(19) United States
(12) Patent Application Publication
(10) Pub. No.: US 2022/0283640 A1
(43) Pub. Date: Sep. 8, 2022

(54) CONTROL DEVICE, PRESENTATION DEVICE, AND DATA

(71) Applicant: KABUSHIKI KAISHA TOKAI RIKA DENKI SEISAKUSHO, Aichi (JP)

(72) Inventors: Mayu MYOKAN, Aichi (JP); Konomu ABE, Aichi (JP); Yasuhiro ONO, Aichi (JP); Toshihito TAKAI, Aichi (JP); Takao ARAYA, Aichi (JP); Yuji MITSUI, Aichi (JP); Keiji NOMURA, Aichi (JP)

(73) Assignee: KABUSHIKI KAISHA TOKAI RIKA DENKI SEISAKUSHO, Aichi (JP)

(21) Appl. No.: 17/625,975

(22) PCT Filed: Apr. 17, 2020
(86) PCT No.: PCT/JP2020/016820

§ 371 Date: Jan. 10, 2022

(30) Foreign Application Priority Data
Jul. 12, 2019 (JP) 2019-130214

(51) Int. Cl. G06F 3/01

(52) U.S. Cl. CPC G06F 3/016; G06F 3/011

(57) ABSTRACT

When a user is made perceive a plurality of sense presentations, strangeness that the user feels is reduced. There is provided a control device that includes a control section configured to control output of at least two or more sense presentations having different presentation modes, and in which the control section performs control such that an interval of output start timings of the at least two or more sense presentations is a specified interval or less that is based on simultaneous perception characteristics that are characteristics that indicate delay that can allow a user to simultaneously perceive the at least two or more sense presentations.

### TECHNICAL FIELD

The present invention relates to a control device, a presentation device, and data.

### BACKGROUND ART

In recent years, various devices that perform sense presentations have been developed. For example, Patent Literature 1 discloses a technology that presents tactile feedback in response to a user's operation of a touch panel.

### CITATION LIST

### Patent Literature

Patent Literature 1: JP 2019-91198A

### SUMMARY OF INVENTION

### Technical Problem

By the way, in a case where it is necessary to make a user perceive a plurality of sense presentations having different presentation modes as intended, it is important to determine a timing to perform sense presentation by taking characteristics of each sense presentation into account.

Hence, the present invention has been made in view of the above problem, and an object of the present invention is to provide a mechanism that can reduce strangeness that a user feels when the user is made perceive a plurality of sense presentations.

### Advantageous Effects of Invention

To solve the above problem, a certain aspect of the present invention provides a control device that includes a control section configured to control output of at least two or more sense presentations having different presentation modes, and in which the control section performs control such that an interval of output start timings of the at least two or more sense presentations is a specified interval or less that is based on simultaneous perception characteristics that are characteristics that indicate delay that can allow a user to simultaneously perceive the at least two or more sense presentations.

Furthermore, to solve the above problem, another aspect of the present invention provides a presentation device that includes a presentation section configured to output at least two or more sense presentations having different presentation modes, and in which the presentation section outputs the at least two or more sense presentations such that an interval of output start timings of the at least two or more sense presentations is a specified interval or less that is based on simultaneous perception characteristics that are characteristics that indicate delay that can allow a user to simultaneously perceive the at least two or more sense presentations.

Furthermore, to solve the above problem, still another aspect of the present invention provides data that causes a presentation device to output at least two or more sense presentations having different presentation modes, and includes a structure including at least two or more definition parts configured to define a presentation mode per sense presentation, and an interval specifying part configured to specify an interval of output start timings of the at least two or more sense presentations presented according to the definition parts as a specified interval or less that is based on simultaneous perception characteristics that are characteristics that indicate delay that can allow a user to simultaneously perceive the at least two or more sense presentations.

### Advantageous Effects of Invention

As described above, the present invention can reduce strangeness that a user feels when the user is made perceive a plurality of sense presentations.

### BRIEF DESCRIPTION OF DRAWINGS

FIG. 1 is a block diagram illustrating a functional configuration example of a system according to an embodiment of the present invention.

FIG. 2 is a view schematically illustrating features related to a plurality of sense presentations output by a presentation section based on control of a control section according to the embodiment.

FIG. 3 is a view for explaining a waveform change due to simultaneous output of auditory presentation and tactile presentation, and prevention of the waveform change according to the embodiment.

FIG. 4A is a view for explaining presentation control based on simultaneous perception target elements according to the embodiment.

FIG. 4B is a view for explaining presentation control based on simultaneous perception target elements according to the embodiment.

### DESCRIPTION OF EMBODIMENTS

A preferred embodiment of the present invention will be described in detail below with reference to the appended drawings. Note that components employing substantially identical functional configurations in the description and the drawings will be assigned the same reference numerals, and overlapping description thereof will be omitted.

### 1. Embodiment

### 1.1 Outline

First, an outline of an embodiment of the present invention will be described. As described above, in recent years, various devices that perform sense presentations have been developed. In this regard, the above sense presentation refers to presentation of a stimulus on some sense that a person can perceive. Hence, the above sense presentations widely include, for example, auditory presentation that is presentation of a stimulus on a sense of hearing, tactile presentation that is presentation of a stimulus on a sense of touch, visual presentation that is presentation of a stimulus on a sense of vision, olfactory presentation that is presentation of a stimulus on a sense of smell, and gustatory presentation that is presentation of a stimulus on a sense of taste.

The above-described sense presentations are used to, for example, notify a user of information. One example is auditory presentation that uses sound for notifying the user of that a terminal has received a mail. Furthermore, feedback of a user's operation is also a sort of information notification. When, for example, the user operates a touch panel, it is also possible to perform tactile presentation that uses vibration as feedback of the operation. In this case, by perceiving the tactile presentation, the user can learn that the operation performed by the user has been correctly detected.

In addition, it is also assumed to adopt a plurality of sense presentations having different presentation modes for the above-described information notification. In this regard, the above presentation mode means contents of various parameters such as a strength or a length, the number of times of presentation, and a presentation interval of one sense presentation type in addition to or instead of a meaning of the sense presentation types (such as auditory presentation, tactile presentation, visual presentation, olfactory presentation, and gustatory presentation).

There are assumed a case where tactile presentation or visual presentation is performed in addition to auditory presentation for the above-described notification related to reception of the mail, and a case where auditory presentation or visual presentation is performed in addition to tactile presentation as feedback of a user's operation.

Thus, in a case where the plurality of sense presentations having the different presentation modes are performed, it is important to determine a timing to perform sense presentation by taking characteristics of each sense presentation into account to, for example, make a user perceive the plurality of sense presentations as intended by a manufacturer, a distributor, a service provider, or the user itself.

For example, a case is assumed where it is necessary to make the user simultaneously perceive the plurality of sense presentations having the different presentation modes. In this case, an output start timing of each sense presentation is very important to make the user perceive that the plurality of sense presentations have been simultaneously performed.

It is assumed that, when, for example, auditory presentation B having a different presentation mode from that of auditory presentation A is output one second after the auditory presentation A having a certain presentation mode is output, the user feels that the auditory presentation A and the auditory presentation B are output at different timings.

On the other hand, when output timings of the auditory presentation A and the auditory presentation B are close to some degree, there are a probability that the user perceives that the auditory presentation A and the auditory presentation B are simultaneously output, and a probability that the user cannot separately perceive the auditory presentation A and the auditory presentation B, and perceives that single auditory presentation has been output.

It is known that temporal resolution of a human sense of hearing relates to such a phenomenon. In this regard, the above temporal resolution refers to capability that indicates how finely a person can separate a certain sense in a time domain and perceive the certain sense.

Such temporal resolutions of senses other than that of the sense of hearing are known. Although, for example, a fluorescent light repeats flashing several tens of times in one second, a human sense of vision perceives that the fluorescent light is continuously lighted. This is because the temporal resolution of the human sense of vision is lower than a flashing speed of the fluorescent light.

In view of the above, in a case where, for example, a plurality of sense presentations such as auditory presentation and auditory presentation or visual presentation and visual presentation whose sense types are identical, and whose other presentation modes are different are performed, it is important to determine an output timing of each sense presentation by taking the above temporal resolution into account to make the user perceive that the plurality of sense presentations have been simultaneously performed.

On the other hand, when a plurality of sense presentations such as auditory presentation and tactile presentation or tactile presentation and visual presentation whose sense types are different are performed, it is important to take into account a propagation speed or a neurotransmission speed related to each sense.

As is remarkable in, for example, a case where the user perceives a sound of thunder accompanied by the thunder, physical propagation speeds of light and sound are not equal. Hence, even when a visual presentation device that outputs visual presentation and an auditory presentation device that outputs auditory presentation are installed at an identical distance from the user, the visual presentation and the auditory presentation do not simultaneously reach user's sensor receptors.

Furthermore, neurotransmission speeds taken until inputs reach sensory centers after being received by the receptors are different between the visual presentation and the auditory presentation. Therefore, there is also a time lag of timings at which signal information related to each sense presentation reaches a primary sensory area and perception takes place.

In view of the above, when it is necessary to make the user simultaneously perceive a plurality of sense presentations of different sense types, it is important to determine an output timing of each sense presentation by taking into account a difference in a propagation speed or a neurotransmission speed related to each sense.

A technological idea of the present invention has been conceived focusing on the above point, and makes it possible to reduce strangeness that the user feels when the user is made perceive a plurality of sense presentations.

### 1.2. Configuration Example

(Control Device 10)

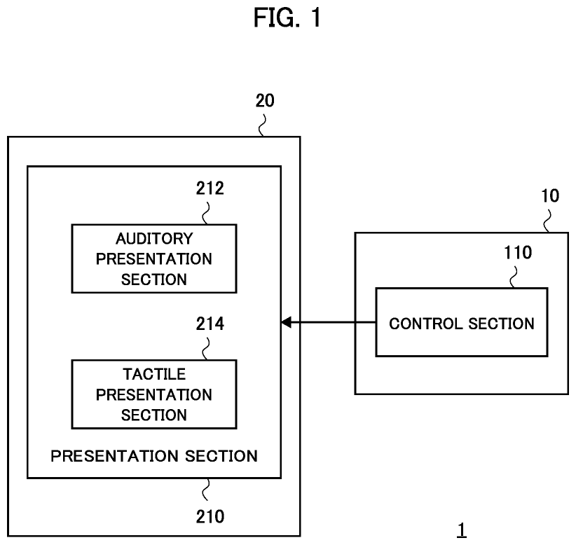

Hence, as illustrated in FIG. 1, the control device 10 according to the embodiment of the present invention includes a control section 110 that controls output of at least two or more sense presentations having different presentation modes. Furthermore, one of features of the control section 110 according to the embodiment of the present invention is that the control section 110 performs control such that an interval of output start timings of the at least two or more sense presentations is a specified interval or less that is based on simultaneous perception characteristics that are characteristics that indicate delay that can allow the user to simultaneously perceive the at least two or more sense presentations.

That is, the control device 10 according to the present embodiment includes a function of controlling intervals of output start timings of a plurality of sense presentations such that the user can perceive that the plurality of sense presentations are simultaneously performed. When, for example, it is necessary to make the user simultaneously perceive the auditory presentation A and the auditory presentation B, the control device 10 starts outputting the auditory presentation B within a specified time after starting outputting the auditory presentation A. According to this control, it is possible to effectively reduce strangeness that the user feels such as a shift of the output timings of the auditory presentation A and the auditory presentation B.

The above at least two or more presentation senses may be presentations of stimuli on senses of respectively different types among presentations of stimuli on a sense of hearing, a sense of touch, a sense of vision, a sense of smell, and a sense of taste. The control section 110 according to the present embodiment may perform control such that, for example, an interval of output start timings of auditory presentation that is presentation of a stimulus on the sense of hearing and tactile presentation that is presentation of a stimulus on the sense of touch is a specified interval or less that is based on simultaneous perception characteristics between the auditory presentation and the tactile presentation.

On the other hand, the above at least two or more presentation senses may be presentations of stimuli on a sense of an identical type. The control section 110 according to the present embodiment may perform control such that, for example, output start timings of two auditory presentations having respectively different presentation modes are a specified interval or less that is based on simultaneous perception characteristics between the respective auditory presentations.

The function of the control section 110 is realized by collaboration of, for example, a processor such as a Central Processing Unit (CPU) or a Micro Controller Unit (MCU), software, and a storage medium such as a Read Only Memory (ROM) or a Random Access Memory (RAM).

The control section 110 according to the present embodiment may be connected with a presentation device 20 via, for example, a network. The network described herein is connection that is necessary for information communication, and may be wired connection that uses a physical cable, or wireless connection that uses wireless communication. An example of wireless communication is Bluetooth (registered trademark) and Wi-Fi (registered trademark).

The control section 110 connected with the presentation device 20 via the network in this way can transmit a control signal (data) to the presentation device 20, and control an output start timing of sense presentation of the presentation device 20.

At this time, the control section 110 may dynamically calculate an interval of the output start timings of a plurality of sense presentations based on simultaneous perception characteristics between the plurality of sense presentations to be output, and control output of the sense presentations of the presentation device 20.

On the other hand, the control section 110 according to the present embodiment may generate data that specifies the interval of the output start timings of the plurality of sense presentations as a fixed value, and transmit the data to the presentation device 20. In this case, the interval of the output start timings may be specified as a fixed time or less that is statically determined in advance.

In this case, the data generated by the control section 110 according to the present embodiment is data that causes the presentation device 20 to output at least two or more sense presentations having different presentation modes, and include at least two or more definition parts that define a presentation mode per sense presentation.

Furthermore, the data according to the present embodiment includes an interval specifying part that specifies an interval of output start timings of the at least two or more sense presentations presented according to the above definition parts as a specified time or less that is based on simultaneous perception characteristics that are characteristics that indicate delay that can allow the user to simultaneously perceive the at least two or more sense presentations.

(Presentation Device 20)

The presentation device 20 according to the present embodiment includes a presentation section 210 that outputs at least two or more sense presentations having different presentation modes. Furthermore, one of features of the presentation section 210 according to the present embodiment is that the presentation section 210 outputs the at least two or more sense presentations such that an interval of output start timings of the at least two or more sense presentations is a specified interval or less that is based on simultaneous perception characteristics that are characteristics that indicate delay that can allow the user to simultaneously perceive the at least two or more sense presentations.

The presentation section 210 according to the present embodiment may realize the above feature according to, for example, dynamic control of the control section 110. On the other hand, the presentation section 210 according to the present embodiment may realize the above feature by processing the above-described data.

Note that FIG. 1 illustrates an example of a case where the presentation section 210 according to the present embodiment includes an auditory presentation section 212 that outputs auditory presentation such as sound, and a tactile presentation section 214 that outputs tactile presentation such as vibration. However, a configuration of the presentation section 210 is not limited to this example, and the presentation section 210 according to the present embodiment is configured to include sense presentation elements that can output at least two or more sense presentations having different presentation modes.

A tactile presentation element for tactile presentation is, for example, a component that performs tactile presentation by means of a vibration stimulus, a component that performs tactile presentation by means of an electrical stimulus, a component that performs tactile presentation by means of a temperature change, a component that performs tactile presentation related to a force sense (e.g., presentation of a sense of being pushed by an object, presentation of a sense of contacting an object, or presentation of a sense of being tightened), or a component that performs tactile presentation related to a cutaneous sense (e.g., presentation of a sense of roughness or presentation of a sense of smoothness).

A component that performs tactile presentation by means of a vibration stimulus is, for example, a solenoid that makes a linear motion according to an input of an electric signal, a Linear Resonant Actuator (LRA) that makes an inertial motion according to an input of an electric signal, an electric motor that makes a rotational motion according to an input of an electric signal, and, moreover, an eccentric motor.

A visual presentation element for visual presentation is a component that includes an image display function, a component that includes a lighting function, and a component such as a dimming glass that can change a transmittance. An olfactory presentation element for olfactory presentation is a component that diffuses a perfume into air. A gustatory presentation element for gustatory presentation is a component that adjusts a taste of a stuff to be put in a mouth cavity, or a component that adjusts a taste of a stuff put in a mouth cavity. An auditory presentation element for auditory presentation is a component such as a speaker or an earphone that causes air vibration, or a component that includes a bone conduction function.

Furthermore, the sense presentation element of the presentation section 210 may be able to simultaneously output sense presentations of different types. This sense presentation element may be, for example, a voice coil motor that can simultaneously output auditory presentation and tactile presentation.

The configuration example of a system 1 according to the present embodiment has been described above. Note that the above configuration described with reference to FIG. 1 is a mere example, and the configuration of the system 1 according to the present embodiment is not limited to this example. For example, the case where the presentation device 20 according to the present embodiment includes the sense presentation elements that can output at least two or more sense presentations having different presentation modes has been exemplified above. However, the control device 10 according to the present embodiment may simultaneously control a plurality of presentation devices, and cause each presentation device to output sense presentations having respectively different presentation modes. The configuration of the system 1 according to the present embodiment can be flexibly altered according to a specification or an operation.

### 1.3. Details of Control

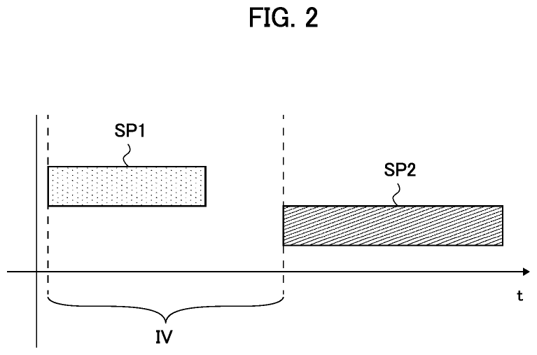

Next, sense presentation control of the control section 110 according to the present embodiment will be described in detail. FIG. 2 is a view schematically illustrating features related to a plurality of sense presentations output by the presentation section 210 based on control of the control section 110. As illustrated in FIG. 2, the control section 110 according to the present embodiment causes the presentation section 210 to output, for example, two sense presentation SP1 and sense presentation SP2.

In this regard, in a case where, for example, both of the sense presentation SP1 and the sense presentation SP2 are sense presentations of an identical type, simultaneous perception characteristics may include the above-described temporal resolution of the sense. In this case, the control section 110 according to the present embodiment may control the presentation section 210 such that an interval IV of output start timings of the sense presentation SP1 and the sense presentation SP2 is a specified interval or less that is based on the temporal resolutions of at least corresponding senses.

According to the above-described control of the control section 110 according to the present embodiment, it is possible to effectively reduce strangeness that the user feels in a case where sense types are identical and it is necessary to make the user simultaneously perceive a plurality of sense presentations whose other presentation modes are respectively different.

On the other hand, in a case where the sense presentation SP1 and the sense presentation SP2 are sense presentations of respectively different types, the simultaneous perception characteristics may include characteristics such as the above-described propagation speed or neurotransmission speed of each sense. In this case, the control section 110 according to the present embodiment may control the presentation section 210 such that the interval IV of the output start timings of the sense presentation SP1 and the sense presentation SP2 is a specified interval or less that is based on the propagation speed or the neurotransmission speed of each sense.

According to the above-described control of the control section 110 according to the present embodiment, it is possible to effectively reduce strangeness that the user feels in a case where it is necessary to make the user simultaneously perceive a plurality of sense presentations of different sense types.

The features of the sense presentations according to the present embodiment have been described above. Note that the above-mentioned simultaneous perception characteristics are a mere example, and the simultaneous perception characteristics according to the present embodiment are not limited to this example. The simultaneous perception characteristics according to the present embodiment may widely include, for example, a distance between the presentation device 20 and the user (a positional relationship between the presentation section 210 of the presentation device 20 and a user's sensory organ), a presentation mode of each sense presentation, characteristics of the presentation device 20, and user's characteristics. The control section 110 according to the present embodiment may control the presentation section 210 such that an interval of output start timings of a plurality of sense presentations is a specified time or less that can be theoretically or experimentally specified based on the above-described various simultaneous perception characteristics.

Next, control in a case where the presentation section 210 according to the present embodiment includes a voice coil motor as a sense presentation element will be described. The voice coil motor that can cause vibrations of wide frequency ranges can realize auditory presentation and tactile presentation by means of a single sense presentation element. However, in a case where output start timings of auditory presentation and tactile presentation are simultaneous, a case is assumed where the auditory presentation and the tactile presentation change to unintended output modes.

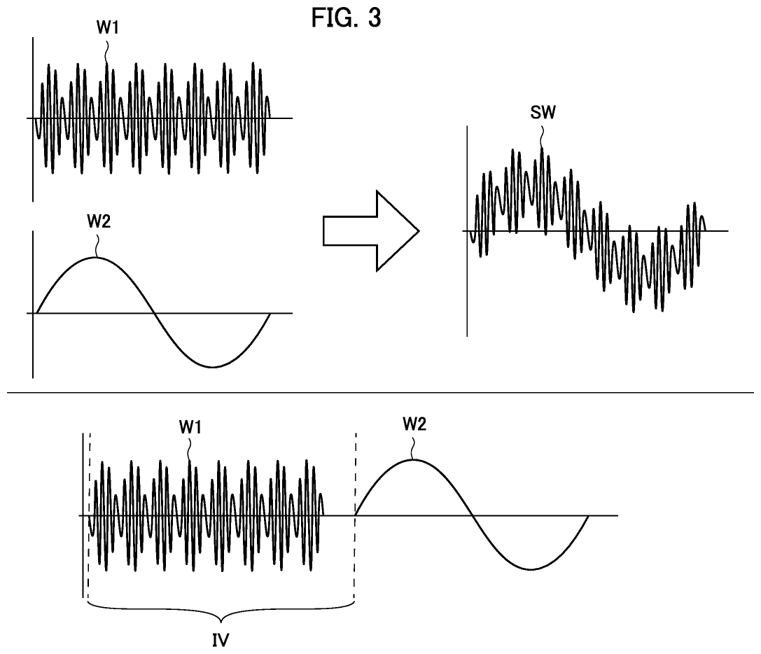

FIG. 3 is a view for explaining a waveform change due to simultaneous output of auditory presentation and tactile presentation, and prevention of the waveform change. An upper left side of FIG. 3 illustrates each of a sound waveform W1 and a vibration waveform W2 input to the voice coil motor. In this regard, when it is necessary to make the user simultaneously perceive auditory presentation that uses the sound waveform W1 and tactile presentation that uses the vibration waveform W2, the sound waveform W1 and the vibration waveform W2 are generally output simultaneously.

However, in the above case, as illustrated in an upper right side in FIG. 3, the sound waveform W1 and the vibration waveform W2 are synthesized, and a synthetic waveform SW of a collapsed waveform different from both of the sound waveform W1 and the vibration waveform W2 is output, and both of auditory presentation and tactile presentation become different from intended presentation modes.

To prevent the above-described situation, the control section 110 according to the present embodiment controls the voice coil motor of the presentation section 210 such that, as illustrated in a lower part of FIG. 3, the interval IV of output start timings of the sound waveform W1 used for auditory presentation and the vibration waveform W2 used for tactile presentation is a specified interval or less that is based on simultaneous perception characteristics of the auditory presentation and the tactile presentation. Furthermore, at this time, the control section 110 according to the present embodiment controls the voice coil motor such that the output start timings of the auditory presentation and the tactile presentation are non-simultaneous. As illustrated in, for example, FIG. 3, the control section 110 may perform control such that output of the vibration waveform W2 is started after output of the sound waveform W1 is finished.

According to the above control of the control section 110 according to the present embodiment, it is possible to prevent the sound waveform W1 and the vibration waveform W2 from being synthesized, and output auditory presentation and tactile presentation in intended presentation modes without noise in a case where it is necessary to make the user simultaneously perceive the auditory presentation and the tactile presentation by using, for example, the voice coil motor.

Next, a case is assumed where each sense presentation according to the present embodiment includes a simultaneous perception target element that is a matter that the user needs to be made simultaneously perceive. In a case where, for example, it is necessary to make the user simultaneously perceive an element A included in the sense presentation SP1 and an element B included in the sense presentation SP1 in the example illustrated in FIG. 2, the above element A and element B are the simultaneous perception target elements.

In this case, the control section 110 according to the present embodiment may perform control such that an interval of output start timings of the simultaneous perception target elements included in at least two or more sense presentations is a specified interval or less that is based on simultaneous perception characteristics between the sense presentations.

According to above control of the control section 110 according to the present embodiment, it is possible to output each sense presentation while emphasizing simultaneity of the simultaneous perception target elements included in each sense presentation, and realize sense presentations that match various intensions.

In a case where, for example, each sense presentation includes a beginning part that is a start part of each sense presentation, a last part that is an end part of each sense presentation, and a peak part at which a stimulus on a sense maximizes during each sense presentation, the simultaneous perception target element according to the present embodiment may be at least one of entirety, the beginning part, the last part, and the peak part of the above sense presentation.

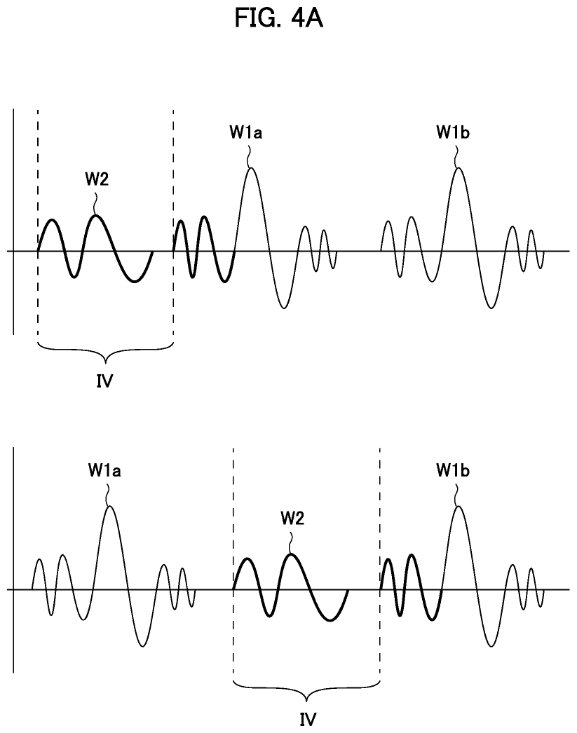

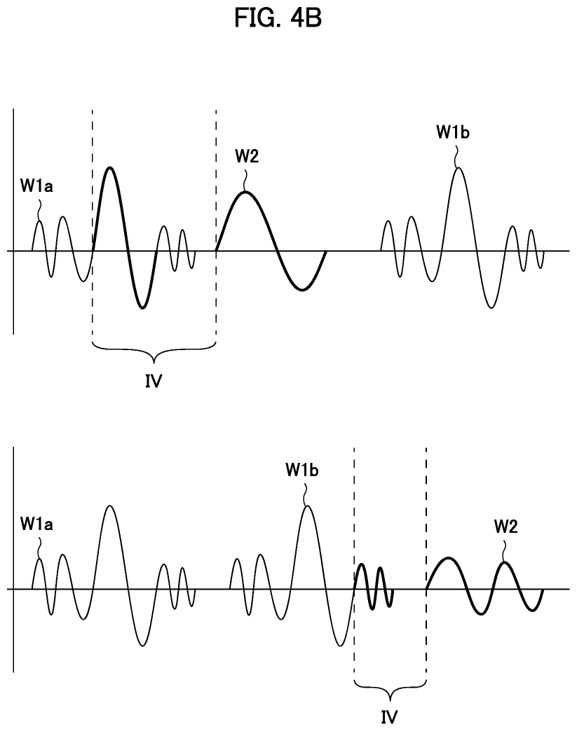

FIGS. 4A and 4B are views for explaining presentation control based on simultaneous perception target elements according to the present embodiment. FIGS. 4A and 4B illustrate examples of a case where, when auditory presentation that uses a sound waveform W1a, auditory presentation that uses a sound waveform W1b, and tactile presentation that uses the vibration waveform W2 are performed, the auditory presentations and the tactile presentation are output while emphasizing the simultaneous perception target elements.

In this regard, the sound waveform W1a and the sound waveform W1b may be substantially identical waveforms. That is, FIGS. 4A and 4B illustrate the examples of the case where auditory presentation that outputs an identical sound is performed two times, and tactile presentation that outputs vibration is performed once. Note that FIGS. 4A and 4B illustrate the simultaneous perception target elements in each waveform by a bolder solid line than those of other elements.

For example, an upper part of FIG. 4A illustrates an example of a case where the simultaneous perception target elements are a beginning part that is a start part of the sound waveform W1a and entirety of the vibration waveform W2. In this case, the control section 110 according to the present embodiment performs control such that the interval W of output start timings of the vibration waveform W2 and the beginning part of the sound waveform W1a is a specified interval or less that is based on simultaneous perception characteristics between the vibration waveform W2 and the sound waveform W1a.

According to the above control of the control section 110 according to the present embodiment, it is possible to make the user simultaneously perceive the tactile presentation that uses the vibration waveform W2 and the beginning part of the first auditory presentation that uses the sound waveform W1a.

Furthermore, for example, a lower part of FIG. 4A illustrates an example of a case where the simultaneous perception target elements are a beginning part that is a start part of the sound waveform W1b and entirety of the vibration waveform W2. In this case, the control section 110 according to the present embodiment performs control such that the interval W of output start timings of the vibration waveform W2 and the sound waveform W1b is a specified interval or less that is based on simultaneous perception characteristics between the vibration waveform W2 and the sound waveform W1b.

According to the above control of the control section 110 according to the present embodiment, it is possible to make the user simultaneously perceive the tactile presentation that uses the vibration waveform W2 and the beginning part of the second auditory presentation that uses the sound waveform W1b.

Furthermore, for example, an upper part of FIG. 4B illustrates an example of a case where the simultaneous perception target elements are a peak part at which a stimulus on a sense of hearing maximizes in the sound waveform W1a and entirety of the vibration waveform W2. In this case, the control section 110 according to the present embodiment performs control such that the interval IV of output start timings of the peak part of the sound waveform W1b and the vibration waveform W2 is a specified interval or less that is based on simultaneous perception characteristics between the sound waveform W1a and the vibration waveform W2.

According to the above control of the control section 110 according to the present embodiment, it is possible to make the user simultaneously perceive the tactile presentation that uses the vibration waveform W2 and the peak part of the first auditory presentation that uses the sound waveform W1a.

Furthermore, for example, a lower part of FIG. 4B illustrates an example of a case where the simultaneous perception target elements are a last part that is an end part of the sound waveform W1b and the entirety of the vibration waveform W2. In this case, the control section 110 according to the present embodiment performs control such that the interval W of output start timings of the last part of the sound waveform W1b and the vibration waveform W2 is a specified interval or less that is based on simultaneous perception characteristics between the sound waveform W1b and the vibration waveform W2.

According to the above control of the control section 110 according to the present embodiment, it is possible to make the user simultaneously perceive the tactile presentation that uses the vibration waveform W2 and the last part of the second auditory presentation that uses the sound waveform W1a.

The example of presentation control based on the simultaneous perception target elements according to the present embodiment has been described above. According to the above-described method, it is possible to output each sense presentation while emphasizing simultaneity of the simultaneous perception target element included in each sense presentation, and realize sense presentations that match various intentions.

In a case where, for example, auditory presentation and tactile presentation are output while emphasizing simultaneity of a beginning part of the auditory presentation and the tactile presentation as feedback of a user's operation of starting some function, an effect that the user can more intuitively perceive that the above start operation has been detected by the system is expected.

On the contrary, in a case where auditory presentation and tactile presentation are output while emphasizing simultaneity of a last part of the auditory presentation and the tactile presentation as feedback of a user's operation of ending some function, an effect that the user can more intuitively perceive that the above end operation has been detected by the system is expected.

Moreover, the control section 110 according to the present embodiment can also perform control such that the simultaneous perception target elements dynamically change. When, for example, repeating auditory presentation and tactile presentation a plurality of times, the control section 110 may change the simultaneous perception target element associated with entirety of tactile presentation in order of a beginning part of auditory presentation, a middle part that is an intermediate part of the auditory presentation, and a last of the auditory presentation. In this case, an effect that the user can intuitively perceive that some notification gradually proceeds from a start to an end is expected.

Note that the above-described simultaneous target elements are mere examples, and the simultaneous target elements according to the present embodiment are not limited to these examples. The simultaneous target elements according to the present embodiment may be arbitrary elements of sense presentation including entirety, a beginning part, a last part, and a peak part of the sense presentation.

Furthermore, the case where, when the beginning part of auditory presentation and the entirety of tactile presentation are simultaneous perception target elements, output of the tactile presentation is started first and, when the peak part or the last part of auditory presentation and the entirety of tactile presentation are simultaneous perception target elements, output of the tactile presentation is started later. However, an order relative to start of output of sense presentation according to the present embodiment is not limited to this example.

On the other hand, there is also assumed a case where the order of start of output of each sense presentation is important for simultaneous perception depending on a presentation mode of each sense presentation and specification of notification. In a case where, for example, tactile presentation and auditory presentation are used as feedback for a user's operation of the touch panel, it is assumed that the user concentrates on a tip of a finger, and therefore there is a probability that a longer allowable delay of the auditory presentation can be taken by starting outputting the tactile presentation first.

Furthermore, the case where even part of the auditory presentation that uses the sound waveform W1a or the sound waveform W1b and the tactile presentation that uses the vibration waveform W2 are not simultaneously output has been exemplified with reference to FIGS. 4A and 4B. However, an interval of output start timings of respective sense presentations according to the present embodiment only needs to be a specified interval or less, and part of each sense presentation may be simultaneously output.

In addition, the control device according to the present embodiment can also automatically generate, for example, a definition part that defines tactile presentation associated with auditory presentation from data including a definition part that defines a presentation mode of the auditory presentation in advance, and perform control such that output start timings of the auditory presentation and the tactile presentation are a specified interval or less that is based on the simultaneous perception. According to this control, it is possible to apply, for example, vibration associated with existing sound data, and make the user simultaneously perceive the sound and the vibration.

<Supplementary Explanation>

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

Furthermore, the effect described in this description is merely explanatory or exemplary, and is not limitative. That is, together with the above effect or instead of the above effect, the technology according to the present disclosure exhibits other effects that are obvious for those who have common knowledge in the technical field from the disclosure of this description.

Furthermore, it is also possible to create a program that causes hardware such as a CPU, a ROM, and a RAM built in a computer to exhibit functions equivalent to those of the components of the control device 10 and the presentation device 20, and it is also possible to provide a non-transitory computer readable recoding medium in which the program is recorded.

### REFERENCE SIGNS LIST

10 control device
110 control section
20 presentation device
210 presentation section
212 auditory presentation section
214 tactile presentation section 214

1. A control device comprising a control section configured to control output of at least two or more sense presentations having different presentation modes,
wherein the control section performs control such that an interval of output start timings of the at least two or more sense presentations is a specified interval or less that is based on simultaneous perception characteristics that are characteristics that indicate delay that can allow a user to simultaneously perceive the at least two or more sense presentations.

2. The control device according to claim 1, wherein
each of the sense presentations includes a simultaneous perception target element that is a matter that the user needs to be made simultaneously perceive, and
the control section performs control such that an interval of output start timings of the simultaneous perception target elements included in the at least two or more sense presentations is a specified interval or less that is based on the simultaneous perception characteristics between the sense presentations.

3. The control device according to claim 2, wherein
each of the sense presentations includes a beginning part that is a start part of the sense presentation, a last part that is an end part of the sense presentation, and a peak part at which a stimulus on a sense maximizes during the sense presentation, and
the simultaneous perception target element is at least one of entirety, the beginning part, the last part, and the peak part of the sense presentation.

4. The control device according to claim 1,
wherein the at least two or more sense presentations are presentations of stimuli on senses of respectively different types among presentations of stimuli on a sense of hearing, a sense of touch, a sense of vision, a sense of smell, and a sense of taste.

5. The control device according to claim 4,
wherein the control section performs control such that an interval of output start timings of auditory presentation and tactile presentation is a specified interval or less that is based on the simultaneous perception characteristics between the auditory presentation and the tactile presentation, the auditory presentation being the presentation of the stimulus on the sense of hearing, and the tactile presentation being the presentation of the stimulus on the sense of touch.

6. The control device according to claim 5, wherein the control section performs control such that the output start timings of the auditory presentation and the tactile presentation are non-simultaneous.

7. A presentation device comprising a presentation section configured to output at least two or more sense presentations having different presentation modes,
wherein the presentation section outputs the at least two or more sense presentations such that an interval of output start timings of the at least two or more sense presentations is a specified interval or less that is based on simultaneous perception characteristics that are characteristics that indicate delay that can allow a user to simultaneously perceive the at least two or more sense presentations.

8. A non-transitory computer readable storage medium having data stored therein, the data causing a presentation device to output at least two or more sense presentations having different presentation modes, the data comprising a structure including
at least two or more definition parts configured to define a presentation mode per sense presentation, and
an interval specifying part configured to specify an interval of output start timings of the at least two or more sense presentations presented according to the definition parts as a specified interval or less that is based on simultaneous perception characteristics that are characteristics that indicate delay that can allow a user to simultaneously perceive the at least two or more sense presentations.
